(19) United States
(12) Patent Application Publication
(10) Pub. No.: US 2009/0224026 A1
(43) Pub. Date: Sep. 10, 2009

(54) ELECTRONIC COMPONENT MOUNTING METHOD

(75) Inventor: Yuusuke Yamamoto, Fukuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/993,918

(22) PCT Filed: Aug. 16, 2006
(86) PCT No.: PCT/JP2006/316436

§ 371 Date: Dec. 26, 2007

(30) Foreign Application Priority Data
Aug. 25, 2005 (JP) 2005-243866

(51) Int. Cl. B23K 31/02

(52) U.S. Cl. 228/179.1

(57) ABSTRACT

An electronic component mounting method that is to mount on a board 3 an electronic component 11 formed with solder bumps 16 on a lower surface thereof Solder paste 19 is printed onto the electrodes 3a of the board 3 and further provided onto the solder bumps 16 by transfer. Thereafter, the solder bumps 16 are put on the electrodes 3a through the solder paste 19. Due to this, even where there is a gap between the solder bump 16 and the electrode 3a, the fused portion of solder is increased in amount by the solder ingredient of the solder paste 19 wherein the fused portion of solder is ensured to wettably spread. This can prevent a poor junction when to mount a thin semiconductor package by soldering.

### TECHNICAL FIELD

The present invention relates to an electronic component mounting method that is to mount an electronic component formed with solder bumps onto a board by soldering.

### BACKGROUND ART

Along with the recent progress in the size reduction and functional improvement for electronic appliances, size and thickness reductions have been achieved for the electronic components including the semiconductor packages to be built in electronic appliances. In addition, further increase in the mounting density is also sought. There is a trend toward adopting a structure stacked with board modules whose electronic components are mounted on the board, as a mounting form coping with such dense mounting (see Patent document 1,for example). In the Patent Document, by mounting on a board a plurality of semiconductor packages formed with solder bumps, a component-mounted board is to be fabricated with density without increasing the board size.

[Patent Document 1] JP-A-2005-26648

### DISCLOSURE OF INVENTION

In the meanwhile, the semiconductor package for use in a stack structure is thin and hence low in rigidity, thus having a nature that warp is readily caused upon a reflow heating for soldering. For this reason, the solder bumps might be floated by such a warp during solder reflow so that the solder bump cannot be normally soldered with the connection electrode of the board. This tends to cause a poor conductivity or a poor junction, e.g. insufficient soldering strength. The problem is encountered commonly where thin semiconductor packages are mounted by soldering without limited to the structure stacked with a plurality of semiconductor packages.

Therefore, it is an object of the present invention to provide an electronic component mounting method capable of preventing against a poor junction when to mount thin semiconductor packages by soldering.

An electronic component mounting method in the present invention is a method that is to mount onto a board an electronic component formed with solder bumps on a lower surface thereof, the method comprising: a solder transfer step of providing a solder paste onto the solder bump by transfer; a mounting step of placing the electronic component on the board and putting the solder bumps on connection electrodes of the board through the solder paste; and a reflow step of heating up the board together with the electronic component and fusing a solder ingredient of the solder bumps and solder paste thereby soldering the electronic component on the board.

According to the invention, the electronic component in a state a solder paste is provided on the solder bumps by transfer is mounted on the board so that the solder bumps are put on the connection electrodes through a solder paste. Due to this, even where there is a gap between the solder bump and the connection electrode, the fused portion of solder is increased in amount by the solder ingredient of the solder paste wherein the fused portion of solder is ensured to wettably spread. This can prevent a poor junction when to mount a thin semiconductor package by soldering.

### BRIEF DESCRIPTION OF DRAWINGS

FIG. 1 is a configuration diagram of a component-mounted board manufacturing line in one embodiment of the present embodiment.

FIG. 2 is plan view of an electronic-component placement apparatus in one embodiment of the invention.

FIG. 3 is a structure explanatory view of an electronic component to be mounted on a board in one embodiment of the invention.

FIG. 4 is a structure explanatory view of an electronic component to be mounted on a board in one embodiment of the invention.

FIGS. 5(a) to 5(e) are process explanatory views of a board manufacturing method in one embodiment of the invention.

FIGS. 6(a) to 6(c) are process explanatory views of a board manufacturing method in one embodiment of the invention.

FIGS. 7(a) to 7(c) are soldering-process explanatory view in the electronic-component mounting method in one embodiment of the invention.

### BEST MODE FOR CARRYING OUT THE INVENTION

An embodiment of the present invention will now be explained with reference to the drawings.

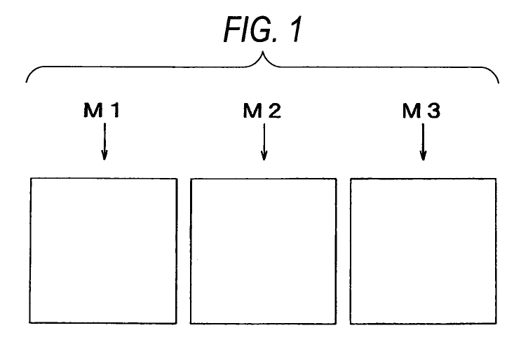

Referring first to FIG. 1, explanation is made on a component-mounted board manufacturing line. In FIG. 1, the component-mounted board manufacturing line is constructed with a screen printer M1, an electronic-component placement apparatus M2 and a reflow apparatus M3 that are arranged in series. The screen printer M1 is to print a solder paste, for connecting thereon an electronic component, onto a board. The electronic-component placement apparatus M2 is to mount an electronic component on a board printed with a solder paste. The reflow apparatus M3 is to heat up the board mounted with electronic components and fuse a solder ingredient of the solder paste, thereby fixing the electronic component on the board.

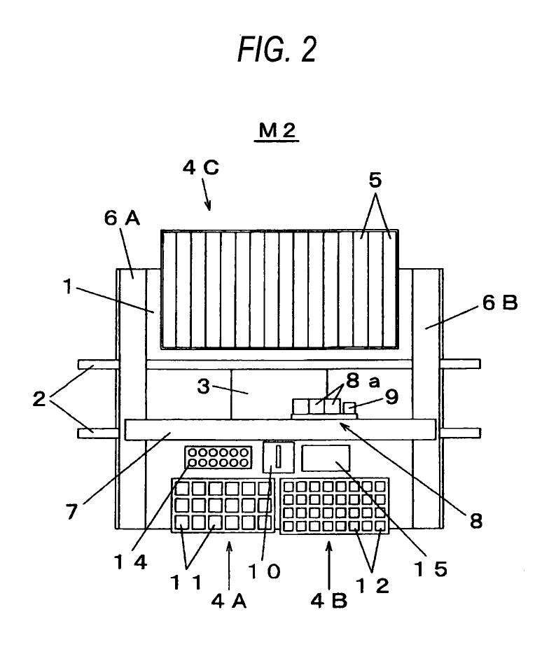

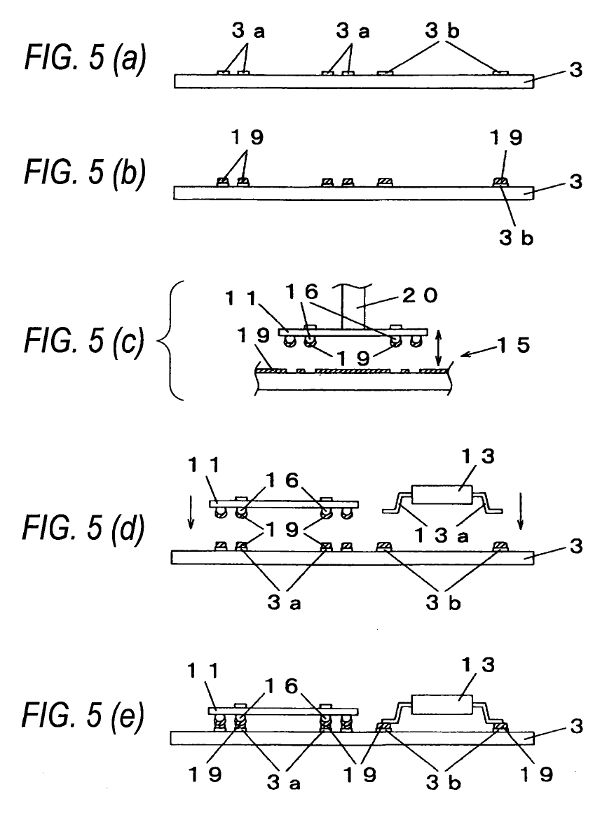

Referring now to FIG. 2, explanation is made on the construction of the electronic-component placement apparatus M2. In FIG. 2, a transport path 2 is arranged in an X direction centrally in a base 1. The transport path 2 is for transporting a board 3 on which electronic components are to be mounted, and for placing the board 3 in a position where to mount an electronic component. In front of the transport path 2, first and second component supply parts 4A and 4B are arranged in parallel with respect to the X direction. The first and second component supply parts 4A and 4B have respective trays where first and second electronic components 11, 12 are contained. A third component supply part 4C is arranged in back of the transport path 2. The third component supply part 4C is arranged with a tape feeder 5 which is to feed intermittently a tape held with third electronic components 13 (see FIG. 5) up to a pickup position of the mount head, explained in the following.

A Y-axis table 6A and a Y-axis guide 6B are arranged at respective ends of the base 1 with respect to the X direction. An X-axis table is suspended between the Y-axis table 6A and the Y-axis guide 6B. The X-axis table 7 is arranged thereon with a mounting head 8. The mounting head 8 is of a gang type having a plurality of unitary heads 8a, to move in unison with a board-recognition camera 9.

By driving the X-axis table 7 and the Y-axis table 6A, the mounting head 8 is moved in the X-axis direction. The unitary heads 8a have respective suction nozzles allowed to take a first electronic component 11 out of a first component supply part 4A, a second electronic component 12 out of a second component supply part 4B, and a third electronic component 13 out of a third component supply part 4C, and then mount those on a board 3 placed on the transport path 2.

Between the transport path 2 and the first and second component supply parts 4A and 4B, there are arranged a line camera 10, a nozzle stocker 14 and a solder-paste transfer table 15. Between the transport path 2 and the third component supply part 4C, arranged are the line camera 10, the nozzle stocker 14 and the solder-paste transfer table 15. The mounting head 8, picked up the electronic components from the component supplies, passes above the line camera 10 in the course moving to the board 3. Due to this, recognition is made of the electronic components that are in a state held by the mounting head 8.

The nozzle stocker 14 accommodates a plurality of types of nozzles suitable for the electronic components to be mounted on the board 3. By accessing of the mounting head 8 to the nozzle stocker 14, suction nozzles can be selectively attached depending upon the electronic component to mount. The paste transfer table 15 is to supply, onto the table, a solder paste, in a thin film state, rendered viscous by mixing a solder ingredient in a flux. By ascending and descending the mounting head held with the electronic components relative to the paste transfer table 15, solder paste is provided onto the solder bumps formed on the underside of the electronic component.

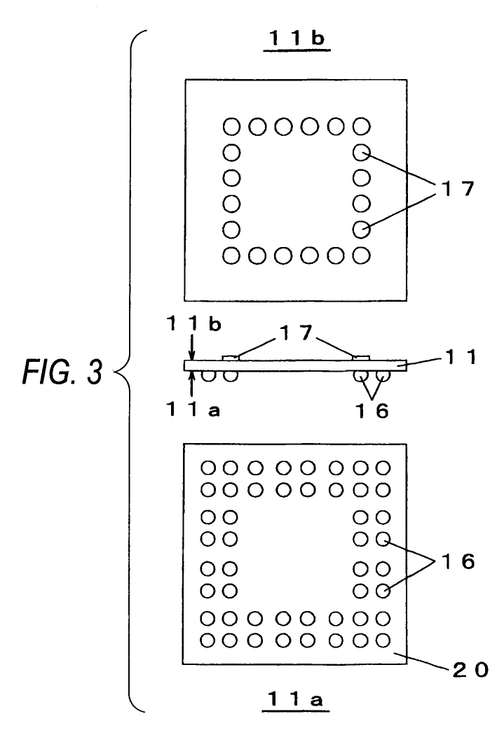

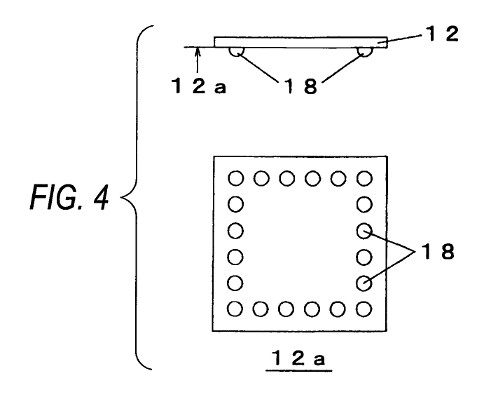

Referring now to FIGS. 3 and 4, explanation is made on the first and second electronic components 11, 12. The first electronic component 11 (electronic component) is a thin package formed by encapsulating a semiconductor element with a resin. As shown in FIG. 3, solder bumps 16 are formed on a lower surface 11a, in order for connection to the board 3. Meanwhile, electrodes 17 (second connection electrode) are formed on an upper surface 11b, in order for connection to an electronic component to be mounted stacked on the first electronic component 11. The second electronic component 12 is also a thin package formed by encapsulating a semiconductor element with a resin. As shown in FIG. 4, on a lower surface 12a, solder bumps 18 are formed in the same arrangement as the electrodes 17 of the first electronic component 12, in order for connection to the first electronic component 11. Those thin packages, low in rigidity, have a property to be readily warped during a reflow heating when connected through solder bumps.

Explanation is now made on an electronic-component mounting method to mount first and second electronic components 11, 12 onto a board 3. By the electronic-component mounting method, first and second electronic components 11, 12 formed with solder bumps in their lower surfaces can be mounted stacked in plurality on a board 3, to thereby form a densely-mounted board.

In FIG. 5(a), electrodes 3a, 3b (connection electrodes) are formed on the upper surface of the board 3. The electrodes 3a are formed in the same arrangement as the bumps 16 of the first electronic component 11 while the electrodes 3b are in the same arrangement as the leads 13 a of the third electronic component 13. The board 3 is first transported to the screen printer M1 shown in FIG. 1 where solder paste 19 is provided onto the electrodes 3a, 3b of the board 3 as shown in FIG. 5(b) (solder printing step). Then, the board 3 supplied with solder is transported to the electronic-component placement apparatus M2 where it is placed in a mounting position on the transport path 2. The mounting head 8 is moved to the above of the board 3 where the board-recognizing camera 9 takes an image of the board 3 thereby recognizing the position of the board 3 (first recognition step).

Thereafter, solder paste is transferred onto the first electronic component 11. Namely, the first electronic component 11, taken out of the first component supply 4A by the mounting head 8, is moved to the paste-transfer table, in a state held by the suction nozzle 20. By ascending and descending the first electronic component 11 relative to the coat film of solder paste 19 as shown in FIG. 5(c), solder paste 19 is supplied, by transfer, to the solder bumps 16 at their lower faces (solder transfer step).

Then, the electronic component transferred with solder paste is mounted onto the solder-printed board 3b by means of the mounting head 8, as shown in FIG. 5(d). At first, the first electronic component 11 (electronic component in the first level) is aligned with the electrodes 3 a of the board 3 depending upon a recognition result in the first recognition step, and then putting the solder bumps 16 on the electrodes 3a thus effecting a mounting (mounting step). In the mounting step, the third electronic component 13 are also mounted through aligning the leads 13a with the electrodes 3b.

Thereafter, an electronic component is mounted in the second level. At first, positional recognition is made on the first electronic component 11 by the board-recognition camera 9. Here, positional recognition is made by recognizing, as featuring points of the electronic component, the electrodes 16 formed in the outermost, diagonal positions of among the electrodes 15 formed on the upper surface 11b of the first electronic component 11 (second recognition step).

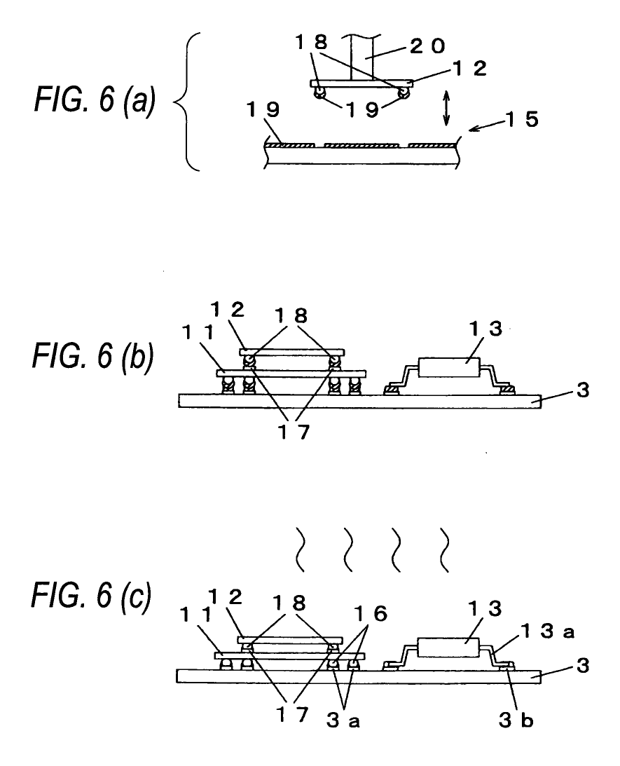

Then, the mounting head 8, picked a second electronic component 12 out of the second component supply 4B, moves to the solder-paste transfer table 15. Here, the second electronic component 12 is ascended and descended relative to the coat film of solder paste 19, as shown in FIG. 6(a). This provides solder paste 19 to the lower faces of the solder bumps 18 by transfer (second solder transfer step). Then, the second electronic component 12 is aligned with the first electronic component 11 depending upon the recognition result in the second recognition step, and mounted thereon by putting the solder bumps 18 of the second electronic component 12 on the electrodes 17 formed on the upper surface of the first electronic component 12 (second mounting step).

Thereafter, the board 3 is transported into the reflow apparatus M3. In this case, the board 3 mounted with the first to third electronic components 11 to 13 is heated together with those electronic components up to a reflow temperature higher than a solder melt point. This causes a soldering of the solder bumps 16 of the first electronic component 11 with the electrodes 3a of the board 3, the leads 13a of the third electronic component 13 with the electrodes 3b, and the solder bumps 18 of the second electronic component 12 with the electrodes 17 of the electronic component 11 (reflow step). The soldering is done by fusing the solder ingredients of the solder bumps 16, 18 and solder paste 19. This completes a densely-mounted board stacked with the packages of the first and second electronic components 11, 12, etc. formed by encapsulating semiconductor elements with resins.

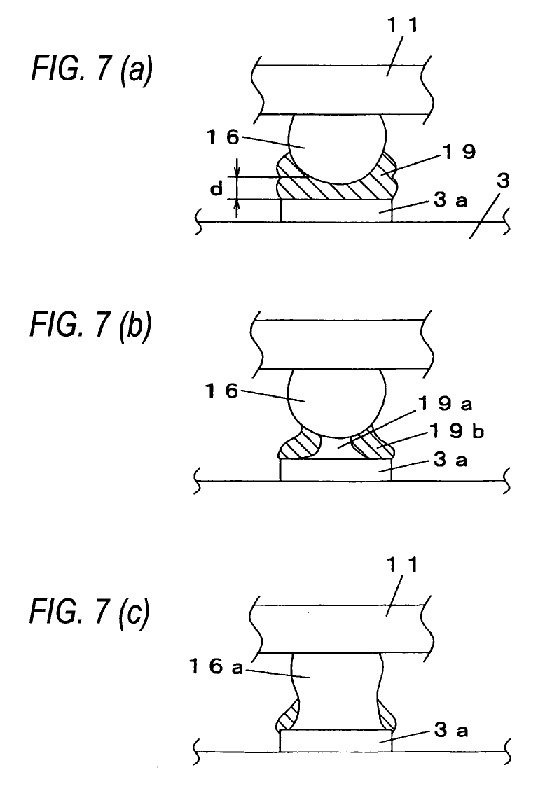

The soldering behavior in the reflow step is explained while referring to FIG. 7. The present embodiment explained on the example the solder bumps 16 of the first electronic component 11 is soldered to the electrodes 3a of the board 3. However, this is true for the case where the solder bumps 18 of the second electronic component 12 is soldered to the electrodes 17 of the first electronic component 11. As stated before, because the first electronic component 11 is a thin semiconductor package, the solder bumps 16 tend to float due to an upward warp of the package body upon mounting the first electronic component 11 onto the board 3 and further during conducting a reflow. This possibly results in a gap d caused between the solder bump 16 and the electrode 3a, as shown in FIG. 7(a).

Even where there is a gap between the solder bump 16 and the electrode 3 a in this manner, the present embodiment transfers a solder paste 19 additionally onto the solder bumps 16 prior to component mounting. Furthermore, solder paste 19 is also provided onto the electrodes 3a. Due to this, the electrode 3a for connection and the solder bump 16 are placed in a state covered around at their upper and lower surfaces by a sufficient amount of solder paste 19.

Then, reflow is performed in such a state. Namely, in the process of fusing the solder due to heating, the solder paste 19 has a fused portion of solder 19a, in a sufficient amount, as a fused solder ingredient thereof This spreads wettably in the viscous liquid resin 19b in the state connecting between the lower end of the solder bump 16 and the electrode 3a, as shown in FIG. 7(b). At this time, the surface tension of the fused portion of solder 19a causes a force acting to pull the solder bump 16 toward the electrode 3a and to narrow the initial existent gap d.

Thereafter, by continuing the heating furthermore, the solder bump 16 fuses into one body with the fused portion of solder 19a. As shown in FIG. 7(c), a solder junction 1 6a is formed connecting between the first electronic component 11 and the electrode 3a. The solder junction 16a is thereafter cooled down and solidified thus completing a soldering of the first electronic component 11 to the board 3. The solder connection 16a is in an amount of the fused solder of the solder bump 16 added with a solder of the solder paste 19. Therefore, the first electronic component 11 and the board 3 are connected together by a sufficient amount of solder, thus ensuring a sufficient soldering strength and conductivity.

Incidentally, the embodiment showed the structure that the first and second electronic components 11, 12 are mounted stacked on the board 3. Besides, the invention can be applied also to the general electronic-component mounting structure other than the stack structure provided that it is in such a mounting form that the package is thin and ready to warp wherein a gap is to be caused between the solder bump and connection electrode. Meanwhile, the embodiment showed the example to previously provide solder also to the connection electrode 3A of the board 3 by printing. However, where the solder to be additionally provided to the solder bump is satisfactorily small in amount because the package warping degree is comparatively small, the provision of solder to the connection electrode may be omitted.

This application is based upon and claims the benefit of priority of Japanese Patent Application No. 2005-243866 filed on Aug. 25, 2005, the contents of which are incorporated herein by reference in its entirety.

### INDUSTRIAL APPLICABILITY

The electronic-component mounting method in the present invention has an effect that poor connection can be prevented in mounting a thin semiconductor packages by soldering, which is useful in the field to mount a thin electronic component formed with solder bumps onto a board by soldering.

1. An electronic component mounting method for mounting onto a board an electronic component formed with solder bumps on a lower surface thereof, the method comprising:
a solder transfer step of providing a solder paste onto the solder bump by transfer;
a mounting step of placing the electronic component on the board and putting the solder bumps on connection electrodes of the board through the solder paste; and
a reflow step of heating up the board together with the electronic component and fusing a solder ingredient of the solder bumps and solder paste thereby soldering the electronic component on the board.

2. An electronic component mounting method according to claim 1, further including a solder printing step of previously printing a solder paste on the connection electrodes.

3. An electronic component mounting method according to claim 1, wherein the electronic component mounted on the board has an upper surface where second connection electrodes are formed to mount thereon a second electronic component formed with second solder bumps on a lower surface thereof,
the method further including a second solder transfer step of providing a solder paste onto the second solder bumps by transfer, and a second mounting step of placing the second electronic component on the electronic component and putting the second solder bumps on the second connection electrodes of the electronic component through the solder paste,
the board in the reflow step being heated up together with the electronic component and second electronic component and fusing a solder ingredient of the second solder bumps and solder paste thereby soldering the second electronic component on the electronic component.

4. An electronic component mounting method according to claim 3, wherein position recognition is performed on the electronic component before mounting the second electronic component on the electronic component.

5. An electronic component mounting method according to claim 4, wherein the position recognition of the electronic component is performed on the electrodes, as a featuring point, formed on the upper surface of the electronic component.

6. An electronic component mounting method according to claim 5, wherein the featuring point is the electrodes formed in outermost, diagonal positions of among the electrodes formed on the upper surface of the electronic component.
